(19) United States
(12) Patent Application Publication
(10) Pub. No.: US 2025/0354529 A1
(43) Pub. Date: Nov. 20, 2025

(54) METHOD FOR INJECTING AN OXIDISER-FUEL GASEOUS MIXTURE

(71) Applicant: VIANNEY RABHI, LYON (FR)

(72) Inventor: VIANNEY RABHI, LYON (FR)

(21) Appl. No.: 19/189,811

(22) Filed: Apr. 25, 2025

Related U.S. Application Data
(60) Provisional application No. 63/647,112, filed on May 14, 2024.

(51) Int. Cl. F02M 21/02

(52) U.S. Cl. CPC F02M 21/0248; F02M 2200/245; F02M 2700/07

(57) ABSTRACT

The method for injecting an oxidiser-fuel gaseous fuel mixture (1) of a pilot charge (39) into an ignition prechamber (2) is to measure the angular position of a crankshaft (7) then, using a filling electrical current profile (22) which imposes a filling lift law (23) on a gaseous fuel mixture injector (9) which opens into said prechamber (2), using a recovery variable (25) which sets the offset between the ignition (41) of the pilot charge (39) in the ignition prechamber (2) and the end of the injection of said charge (39), using a triggering variable of the the filling electrical current profile (26), using a richness variable (27), in order to generate, for each operating point of an internal combustion engine (4), an injection data set (28), then to execute said set (28).

The present invention relates to a method for injecting an oxidiser-fuel gaseous mixture into an ignition prechamber, said method making it possible to adjust the energy and the combustion power of said mixture in said prechamber, in order to maximise the thermodynamic efficiency of an internal combustion engine, to reduce its polluting emissions, to facilitate its starting at all temperatures, and to improve its dynamic, acoustic and vibratory behavior.

The maximum effective efficiency of reciprocating internal combustion heat engines used in automobiles is of the order of thirty-eight percent in the case of Otto cycle spark ignition engines, and about forty percent in the case of diesel cycle engines.

Regarding the average efficiency in current use of said engines, it is most often less than twenty-five percent for spark ignition engines, and thirty percent for diesel engines, which leads to significant greenhouse gas emissions and an accelerated depletion of fossil energy resources, mainly petroleum.

In addition to low efficiency, these engines produce polluting gases and fine particles harmful to the environment and health.

Despite these not very advantageous characteristics, due to the lack of alternative solutions offering a better energy, environmental, functional, and economic compromise, Otto or Diesel cycle internal combustion heat engines equip the vast majority of motor vehicles in circulation around the world.

The supremacy of combustion vehicles comes from the fact that they are inexpensive to produce, recharge in a few minutes, offer great autonomy, and consume mainly oil, that is to say abundant and distributed energy at low prices almost everywhere on the planet.

However, in view of the risks that the oil resource poses to the climate and to the energy sovereignty of oil-importing countries, the states of many countries discourage motorists from buying combustion-engine cars by overtaxing them, and encourage said motorists to buy electric vehicles by means of purchase aids.

Despite this state interventionism, the electrification of the automobile is met with resistance from motorists who are reluctant to buy electric cars that, even subsidised, remain more expensive than their combustion counterparts, are more limited in autonomy, and take longer to recharge.

To these obstacles to the development of electric cars are added the often problematic access to a charging socket at home or at work, an uncertain resale value, high repair and insurance costs, and an ecological and environmental assessment over the entire mixed life cycle.

In addition, the significant pressure exerted by the “all-electric” strategy on mineral resources and on electricity production makes the projections on the effective future penetration of electric cars uncertain.

Taking into account the uncertainties about the future of the electric car, and the growing environmental and energy constraints, improving the energy efficiency of reciprocating internal combustion heat engines seems essential, due to the large market share of said engines and their high potential for commercial deployment.

Alongside said improvement, the development of low-carbon or carbon-neutral fuels such as electro-fuels produced from green hydrogen and carbon dioxide directly captured in the atmosphere seems to be the way to go, in addition to producing a sustainable share of biofuels from biomass.

One of the most effective strategies for increasing the efficiency of spark ignition reciprocating internal combustion heat engines is to equip them with ignition prechambers known per se, generally one per cylinder.

The ignition prechambers are designed to emit, via ignition torch emission openings, high-temperature ignition torches in the main combustion chamber of said engines, in the form of turbulent jets, in order to ignite therein a main charge composed of air and fuel contained in said chamber.

The ignition torches give off an ignition energy several hundred to several thousand times greater than that delivered by a spark produced between the electrodes of a spark plug, and said torches deploy at high rate in the internal three-dimensional volume of the combustion chamber, generating vigorous local turbulence as they pass, all causing rapid and efficient combustion of the main charge.

To obtain this result, a pilot charge is introduced into the ignition prechamber either in whole or in part by the ignition torch emission openings, or in whole or in part by an injector which opens into said prechamber, or by both, before being ignited by a spark plug known per se, which also opens into said prechamber.

To be effective in igniting the main charge and ensuring rapid combustion, conducive to the efficiency of the combustion engine, the pilot charge must be highly flammable and reactive, i.e. contain little residual burnt gas from the previous cycle.

This need gives all its interest to the valve ignition prechamber which is the subject of the patent belonging to the applicant published on Jul. 19, 2018 under the number WO 2018/130772, and to its main improvements, whose patents, which also belong to the applicant, have been published in particular under the N° WO2020053501 and WO 2022/079367, said valve separating the internal volume of the prechamber from that of the main chamber.

Unlike the pilot charge which must remain pure, the main charge must be diluted with a gas which does not participate in the combustion but which reduces the average temperature of the gases during the combustion of said main charge, reduces the production of nitrogen oxides, and increases the intake pressure of the combustion engine which promotes its efficiency at partial charges.

Thus diluted, the main charge limits heat losses at the internal walls of the main combustion chamber, which is also favorable to the energy efficiency of the combustion engine.

Ideally, the main charge should be diluted with a non-reactive gas that allows the combustion engine to run at stoichiometry, and that acts as a knock moderator to prevent any detonating combustion of the main charge, destructive for said engine.

Moderating the knock makes it possible to set a high compression ratio to the combustion engine, which promotes its energy efficiency, and to stall the combustion of the main charge of said engine at the optimum efficiency, these two actions reducing the energy consumption of said engine for the same work produced.

The most obvious way to dilute the main charge with an additional non-reactive gas is to add to the combustion engine an exhaust gas recirculation device called “EGR”, which is the acronym for the English name “Exhaust Gas Recirculation”, in order to both maintain a stoichiometric main charge, and to moderate knock.

A stoichiometric main charge is necessary to post-treat the pollutants that were produced during the combustion of the main charge by means of a trifunctional catalyst, the latter being notoriously efficient, economical, and widely used in the automotive industry and around the world.

Indeed, engines with an ignition prechamber which operate in a lean mixture and which are therefore non-stoichiometric and operate in excess air, require a complex and expensive device for post-treatment of nitrogen oxides by selective catalytic reduction.

The efficiency of these spark ignition engines is comparable to that of equivalent diesel engines, and have the same pollutant post-treatment constraints, so that producing them is of no interest.

In practice, only engines with an ignition prechamber operating at stoichiometry and whose main charge is diluted with EGR are of real commercial interest because of their high efficiency, on the one hand, and the possibility of post-treating the pollutants by means of a simple trifunctional catalyst, on the other hand.

However, such engines require that a fuel mixture—and not a fuel alone unlike engines operating in excess oxygen—be introduced into their ignition prechamber, said mixture having preferably been pre-prepared before its introduction into said prechamber so as to have the desired fuel richness, and to be perfectly homogeneous.

The prior preparation of said fuel mixture is the objective of the forced recirculation mixer whose patent belonging to the applicant was published on Nov. 4, 2021 under No. WO2021219943, said mixer cooperating with a source of pressurised air such as a compressor known per se.

Said fuel mixture is then introduced into the ignition prechamber by an injector whose tip opens into said prechamber.

It can be seen that the way in which the injector injects said fuel mixture has a strong impact on the progress of combustion in the ignition prechamber and, by cascade effect, on the progress of combustion in the main combustion chamber of the combustion engine.

In particular, the turbulence with which the fuel mixture is animated in the ignition prechamber has strong consequences on the rate of combustion of said mixture in said prechamber, and on the rate of ejection of the ignition torches into the main combustion chamber.

In this respect, if the spark plug ignites the fuel mixture in said prechamber when the mixture injector has finished injecting, the turbulence of said mixture is low and its combustion rate is slow.

In this case, the ignition torches are ejected at low speed into the main chamber which avoids excessive overmixing of said hot torches with the cold main charge, and avoids extinction of the incipient flame and a misfire of said charge, particularly when it is diluted with EGR.

If, on the contrary, the spark plug ignites the fuel mixture in said prechamber while the mixture injector is injecting, the turbulence of said mixture is high as is its combustion rate.

In this case, the ignition torches are ejected at high speed into the main chamber to ignite reactive main charges either diluted with fresh air or slightly diluted with EGR, for example when the combustion engine is running at high speed and at moderate load, and to burn said main charges in a minimum time which makes it possible to escape the knock and to deliver a high thermodynamic efficiency.

However, an excess of slowness or speed of combustion of the pilot charge is detrimental to the efficiency of the combustion engine, and the energy and the combustion power of the pilot charge should ideally always be adapted to the nature of the main charge and the operational conditions of said engine.

In view of the above, it can be seen that the way in which the mixture injector introduces the pilot charge into the ignition prechamber has a direct consequence in particular on the efficiency and/or torque and power performance of the combustion engine.

Indeed, the same amount of pilot charge can be introduced into the ignition prechamber over a longer or shorter period of time depending on whether the injector is partially opened at low flow rate for a long time or is kept fully open at high flow rate for a short time, all the variants between these two extremes can be retained.

This is why the method and the means implemented for injecting the pilot charge relative to the ignition of said charge are decisive for the energy efficiency of the internal combustion heat engine on the one hand, and for the quantity of pollutants produced by said engine on the other hand, as well as for the stability and the acoustic and vibrational emissions of said engine.

In this respect, the method for injecting an oxidiser-fuel gaseous fuel mixture according to the invention can be applied to any internal combustion heat engine with an ignition prechamber as soon as the latter receives a homogeneous gaseous fuel mixture injector, said method making it possible in particular to adjust the quantity, the energy and the rate of combustion of said mixture in said prechamber, which makes it possible, according to a particular embodiment of said method:
To maximise the energy efficiency of said engine regardless of its operating point, whether said engine is operating at stabilised or transient load speed, cold start, temperature transient, hot operation, and over the entire torque and power range;
To minimise the amount of pollutants produced by the combustion of the main charge in the main combustion chamber of said engine;
To optimise the operation of the pollutant aftertreatment devices that cooperate with said engine;
To optimise the stability of said engine and better control acoustic and vibratory emissions;
In general, to optimise the efficiency of the pilot charge to produce the desired effects on the combustion of the main charge.

To achieve these objectives, the method for injecting an oxidiser-fuel gaseous fuel mixture according to the invention makes it possible, on the basis of a set of measurable parameters, to apply to the terminals of an electrically controlled injection actuator of an oxidiser-fuel gaseous fuel mixture injector, an injector electrical current profile such that said actuator imposes on an injector needle comprised in said injector a filling lift law which makes it possible, inter alia, and simultaneously, to adjust the quantity of an oxidiser-fuel gaseous fuel mixture introduced into an ignition prechamber as a pilot charge, and to adjust the rate of combustion of said mixture.

It is understood that the method for injecting an oxidiser-fuel gaseous fuel mixture according to the invention is intended, in addition to reciprocating internal combustion heat engines, for any other application which is similar in concept and in principle and which could advantageously exploit the particular characteristics and functionalities of said injection method according to the invention.

The other features of the present invention have been described in the description and in the secondary claims depending directly or indirectly on the main claim.

The method for injecting an oxidiser-fuel gaseous fuel mixture according to the present invention into an ignition prechamber which comprises a cylinder head of a spark ignition reciprocating internal combustion engine, said prechamber having at least one ignition torch emission opening which opens into a main combustion chamber which comprises said engine and into which a main charge consisting of an oxidiser and a fuel can be introduced, said engine also comprising at least one crankshaft, at least one camshaft, and at least one gaseous fuel mixture injector which opens into the ignition prechamber, said injector comprising at least one injector needle which can either rest in a sealed manner on a needle seat, said injector then being closed, or can be lifted from said seat by an electrically controlled injection actuator controlled by a computer, said injector then being open, which has the effect of introducing into said prechamber a pilot charge formed by a gaseous fuel mixture which consists of an oxidiser and a fuel and which has previously been pressurised by compression means, said mixture having been formed in an oxidiser-fuel mixer, while the ignition of the pilot charge in the ignition prechamber can be triggered by the computer by means of a spark plug which opens into said prechamber, consists in:
Measuring, by means of a crankshaft angular position sensor, the crankshaft angular position CA to transmit to the computer the angular position of the crankshaft relative to that of the internal combustion engine;
Using at least one filling electrical current profile that can be applied by the computer to electrical supply terminals that the electrically controlled injection actuator has, said profile being provided to impose on the injector needle a filling lift law from which, on the one hand, the temporal evolution of the position of said needle relative to that of the needle seat with which it cooperates, and, on the other hand, a filling opening period of the gaseous fuel mixture injector;
Using a recovery variable that sets the offset between, on the one hand, the crankshaft angular position CA at the time of ignition of the pilot charge in the ignition prechamber by the spark plug, and, on the other hand, the crankshaft angular position CA at the time of resting the injector needle on the needle seat with which it cooperates;
Using a triggering variable of the filling electrical current profile that sets, according to the recovery variable, the crankshaft angular position CA from which the computer applies the filling electrical current profile to the electrical supply terminals of the electrically controlled injection actuator, said triggering variable being calculated by said computer, on the one hand, from the crankshaft angular position CA where the ignition of the pilot charge is triggered in the ignition prechamber by the computer, and, on the other hand, from the filling opening period of the gaseous fuel mixture injector that is imposed by the filling electrical current profile;
Using a richness variable that sets the mass proportion of oxidiser and fuel that makes up the gaseous fuel mixture constituting the pilot charge produced by the oxidiser-fuel mixer;
Generating for each operating point of the engine an injection data set which comprises a filling electrical current profile, a value assigned to the recovery variable, a value assigned to the triggering variable of the filling current profile, and a value assigned to the richness variable, said set setting the quantity, the composition and the turbulence of the gaseous fuel mixture constituting the pilot charge at the time of ignition of said mixture, which determines the rate of combustion of said mixture in the ignition prechamber on the one hand, and the heat power released by said combustion on the other hand;
Executing the injection data set corresponding to the operating point of the internal combustion engine.

The method for injecting a gaseous fuel mixture according to the present invention consists in:
Using a triggering variable of the scavenging electrical current profile that sets a crankshaft angular position CA;
Applying, to the crankshaft angular position CA resulting from the triggering variable of the scavenging electrical current profile and via the computer, a scavenging electrical current profile to the electrical supply terminals of the electrically controlled injection actuator, said scavenging profile being provided to impose on the injector needle a scavenging lift law from which follows, on the one hand, the temporal evolution of the position of said needle relative to the needle seat, and, on the other hand, a scavenging opening period of the gaseous fuel mixture injector.

The method for injecting a gaseous fuel mixture according to the present invention consists in:
Measuring by means of an injector needle position sensor the distance d between the injector needle and the needle seat to transmit in real time said distance d to the computer;
Correcting the filling electrical current profile if the latter does not lead, on the one hand, to the filling lift law of the injector needle, and, on the other hand, to the filling opening period of the gaseous fuel mixture injector, as originally provided for by said profile.

The method for injecting a gaseous fuel mixture according to the present invention consists in:
Measuring by means of an injector needle position sensor the distance d between the injector needle and the needle seat to transmit in real time said distance d to the computer;
Correcting the scavenging electrical current profile if it does not lead, on the one hand, to the scavenging lift law of the injector needle, and, on the other hand, to the scavenging opening duration of the gaseous fuel mixture injector, as originally provided for by said profile.

The method for injecting a gaseous fuel mixture according to the present invention consists in:
Measuring by means of a prechamber pressure sensor the pressure p prevailing in the ignition prechamber to transmit said pressure p to the computer in real time;
Correcting the filling injector electrical current profile if said profile does not lead to a prechamber filling pressure profile as it should be, taking into account the operating conditions of the internal combustion engine.

The method for injecting a gaseous fuel mixture according to the present invention comprises a filling lift-flow conversion model which determines, from the operating conditions of the internal combustion engine, from the filing lift law, and from the pressure measured by a pressure sensor and the temperature measured by a temperature sensor of the gaseous fuel mixture to be introduced into the ignition prechamber by the gaseous fuel mixture injector, a mass flow rate of gaseous fuel mixture constituting the pilot charge which is actually introduced by said injector into said prechamber.

The method for injecting a gaseous fuel mixture according to the present invention comprises a scavenging lift-flow conversion model which determines, from the operating conditions of the internal combustion engine, from the scavenging lift law, and from the pressure measured by a pressure sensor and the temperature measured by a temperature sensor of the gaseous fuel mixture to be introduced into the ignition prechamber by the gaseous fuel mixture injector, a mass flow rate of scavenging gaseous fuel mixture which is actually introduced by said injector into said prechamber.

The method for injecting a gaseous fuel mixture according to the present invention comprises a filling electrical current profile, a recovery variable, a richness variable, an injection data set, a scavenging profile and a triggering variable of the scavenging electrical current profile which are recorded in the memory of the computer and/or calculated in real time by the latter.

The method for injecting a gaseous fuel mixture according to the present invention consists in:
Measuring, by means of a camshaft angular position sensor, the camshaft angular position CSA to transmit to the computer the angular position of the camshaft relative to that of the internal combustion engine;
Using the camshaft angular position CSA to determine which crankshaft revolution of the internal combustion engine is assigned to the triggering variable of the filling electrical current profile and the triggering variable of the scavenging electrical current profile.

The other features of the present invention have been described in the description and in the secondary claims depending directly or indirectly on the main claim.

The following description given by way of non-limiting examples and with reference to the accompanying drawings, makes it possible to understand better the invention, the features that it presents, and the advantages that it is likely to provide:

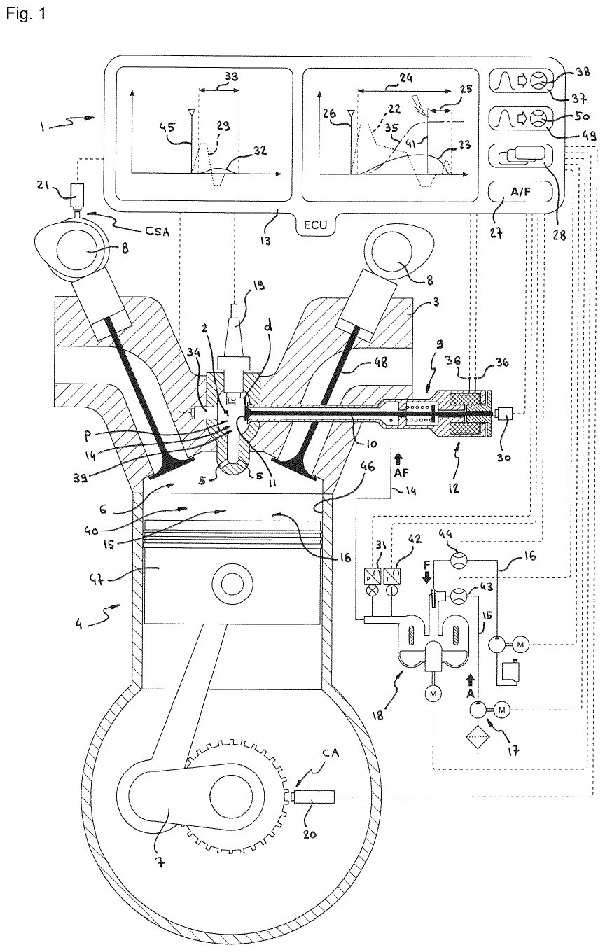

FIG. 1 is a schematic representation of the method for injecting an oxidiser-fuel gaseous mixture according to the invention and a schematic section of the internal combustion engine and its accessories to which said method is intended.

### DESCRIPTION OF THE INVENTION

FIG. 1 shows the method for injecting an oxidiser-fuel gaseous mixture 1 according to the invention, various details of its components, its variants, and its accessories.

FIG. 1 shows that the method for injecting an oxidiser-fuel gaseous mixture 1 according to the invention applies to an ignition prechamber 2 that comprises a cylinder head 3 of a spark ignition reciprocating internal combustion engine 4, said prechamber 2 being designed to emit ignition torches in the form of hot gases.

The ignition prechamber 2 has at least one ignition torch emission opening 5 which opens into a main combustion chamber 6 comprised in the internal combustion engine 4 and into which a main charge 40 consisting of an oxidiser 15 and a fuel 16 can be introduced.

The internal combustion engine 4 also comprises at least one crankshaft 7, at least one camshaft 8, and at least one gaseous fuel mixture injector 9 which opens into the ignition prechamber 2.

The gaseous fuel mixture injector 9 comprises for its part at least one injector needle 10 which can either rest in a sealed manner on a needle seat 11, said injector 9 then being closed, or can be lifted from said seat 11, that is to say be held at a distance from said seat 11, by an electrically controlled injection actuator 12 controlled by a computer 13, the latter consisting of one or more modules which may or may not be separate.

The electrically controlled injection actuator 12 can be directly or indirectly controlled, and of electromagnetic, piezoelectric, electro-hydraulic, electro-pneumatic type, and stepped or non-stepped control.

When the gaseous fuel mixture injector 9 is open, it introduces into the ignition prechamber 2 a pilot charge 39 formed of a gaseous fuel mixture 14 which is as homogeneous as possible and which consists, on the one hand, of an oxidiser 15 such as atmospheric air, and, on the other hand, of a fuel 16 such as, for example, gasoline, ethanol, hydrogen or methane.

Before being introduced into the ignition prechamber 2 by the gaseous fuel mixture injector 9, the gaseous fuel mixture 14 constituting the pilot charge 39 was previously pressurised by compression means 17 consisting, for example, of a piston, a vane compressor or any other type known to the person skilled in the art, said mixture 14 having been formed in an oxidiser-fuel mixer 18 which can be a carburetor, a mixer such as that described in the patent WO2021219943 belonging to the applicant, or any other mixing device known or not known to the person skilled in the art.

The ignition 41 of the pilot charge 39 in the ignition prechamber 2 can be triggered by the computer 13 by means of a spark plug 19 which opens into said prechamber 2, and more precisely in most cases by a spark produced between the electrodes of said plug 19.

It has been shown in FIG. 1 that the method for injecting an oxidiser-fuel gaseous mixture 1 according to the invention consists in measuring, by means of a crankshaft angular position sensor 20, the crankshaft angular position CA to transmit to the computer 13 the angular position of the crankshaft 7 relative to that of the internal combustion engine 4.

The crankshaft angular position sensor 20 may consist of an angular encoder or a phonic wheel known per se.

The method for injecting an oxidiser-fuel gaseous mixture 1 according to the invention also consists in using at least one filling electrical current profile 22 of variable intensity and therefore of variable voltage as a function of time, said profile 22 being able to be applied by the computer 13 to electrical supply terminals 36 of the electrically controlled injection actuator 12.

The filling electrical current profile 22 is provided to impose on the injector needle 10 a filling lift law 23 from which follows, on the one hand, the temporal evolution in the position of said needle 10 relative to that of the needle seat 11 with which it cooperates, and, on the other hand, a filling opening period 24 of the gaseous fuel mixture injector 9.

The filling lift law 23 can take an infinity of forms while the filling opening period 24 of the gaseous fuel mixture injector 9 can advantageously be expressed as an angular sector of the crankshaft 7 rotation during which the injector needle 10 is open and introduces the gaseous fuel mixture 14 into the ignition prechamber 2, said filling lift law 23 and said filling opening period 24 being adapted to each operating point of the internal combustion engine 4 to serve, separately or commonly, objectives of efficiency, polluting emissions and dynamic performance of said engine 4.

As shown in FIG. 1, the method for injecting an oxidiser-fuel gaseous mixture 1 according to the invention also consists in using at least one recovery variable 25 that sets the offset between, on the one hand, the crankshaft angular position CA at the time of ignition 41 of the pilot charge 39 in the ignition prechamber 2 by the spark plug 19, and, on the other hand, the crankshaft angular position CA at the time of resting the injector needle 10 on the needle seat 11 with which it cooperates, said offset possibly being expressed, for example, in degrees of rotation of the crankshaft 7.

The recovery variable 25 may be positive and in this case, the ignition 41 of the pilot charge 39 in the ignition prechamber 2 occurs while the injector needle 10 is still lifted from the needle seat 11, or negative, the ignition 41 of the pilot charge 39 in said prechamber 2 occurring only after the injector needle 10 has returned into contact with the needle seat 11.

The recovery variable 25 is mainly provided to adapt the level of turbulence of the gaseous fuel mixture 14 present in the ignition prechamber 2 at the time of its ignition 41, in order to adjust the combustion rate of the pilot charge 39 thus constituted, and in order to optimise the efficiency and power, and to limit the polluting emissions of the internal combustion engine 4 according to the operating point of the latter, and according to the objectives associated with this point.

FIG. 1 also illustrates that the method for injecting an oxidiser-fuel gaseous mixture 1 according to the invention also uses a triggering variable of the filling electrical current profile 26 which sets, according to the recovery variable 25, the crankshaft angular position CA from which the computer 13 applies the filling electrical current profile 22 to the electrical supply terminals 36 of the electrically controlled injection actuator 12.

The triggering variable of the filling electrical current profile 26 is calculated by said computer 13, on the one hand, from the crankshaft angular position CA where the ignition 41 of the pilot charge 39 in the ignition prechamber 2 is triggered by the computer 13 via the spark plug 19, and, on the other hand, from the filling opening period 24 of the gaseous fuel mixture injector 9 which is imposed by the filling electrical current profile 22.

In FIG. 1, it has also been shown that the method for injecting an oxidiser-fuel gaseous mixture 1 according to the invention uses a richness variable 27 expressed for example in grams of fuel per gram of oxidiser, which sets the mass proportion of oxidiser 15 and fuel 16 which composes the gaseous fuel mixture 14 constituting the pilot charge 39 produced by the oxidiser-fuel mixer 18, the computer 13 being able to control said mixer 18 to produce said proportion.

FIG. 1 also shows that the method for injecting an oxidiser-fuel gaseous mixture 1 according to the invention generates, for each operating point of the engine 4, an injection data set 28 which comprises a filling electrical current profile 22, a value assigned to the recovery variable 25, a value assigned to the triggering variable of the filling current profile 26, and a value assigned to the richness variable 27.

The injection data set 28 sets the quantity, the composition and the turbulence of the gaseous fuel mixture 14 constituting the pilot charge 39 at the time of ignition 41 of said mixture 14, which determines the rate of combustion of said mixture 14 in the ignition prechamber 2, on the one hand, and the heat power released by said combustion, on the other hand.

It is noted that tendentially, the more the ignition 41 of the gaseous fuel mixture 14 in the ignition prechamber 2 takes place while the injector needle 10 is away from the needle seat 11 and that the flow rate of the gaseous fuel mixture 14 entering said prechamber 2 is high, the higher the rate of combustion of said mixture 14.

As shown in FIG. 1, the method for injecting an oxidiser-fuel gaseous mixture 1 according to the invention can consist in using a triggering variable of the scavenging electric current profile 45 which sets a crankshaft angular position CA.

In this case, the method for injecting an oxidiser-fuel gaseous mixture 1 according to the invention also consists in applying to the crankshaft angular position CA resulting from the triggering variable of the scavenging electrical current profile 45 and via the computer 13, a scavenging electrical current profile 29 to the electrical supply terminals 36 of the electrically controlled injection actuator 12 said scavenging profile 29 preceding the filling electrical current profile 22.

Still in this case, the scavenging electrical current profile 29 is provided to impose on the injector needle 10 a scavenging lift law 32 from which follows, on the one hand, the temporal evolution of the position of said needle 10 relative to the needle seat 11, and, on the other hand, a scavenging opening period 33 of the fuel gaseous mixture injector 9.

It should be noted that the purpose of the scavenging lift law 32 is to sweep the ignition prechamber 2 with fresh gaseous fuel mixture 14, and to replace the burnt gases that result from the previous combustion with said fresh mixture 14.

FIG. 1 also shows that the method for injecting an oxidiser-fuel gas mixture 1 according to the invention can consist in measuring, by means of an injector needle position sensor 30, the distance d between the injector needle 10 and the needle seat 11 to transmit said distance d to the computer 13 in real time.

In this case and according to this variant, the method for injecting an oxidiser-fuel gaseous mixture 1 according to the invention consists in correcting the filling electrical current profile 22 if the latter does not lead, on the one hand, to the filling lift law 23 of the injector needle 10 and, on the other hand, to the filling opening period 24 of the gaseous fuel mixture injector 9, as originally provided for by said profile 22, as long as said law 23 and said period 24 are not sufficiently close to what was originally provided for by said profile 22.

As shown in FIG. 1, the method for injecting an oxidiser-fuel gaseous mixture 1 according to the invention can also consist in measuring by means of a prechamber pressure sensor 34 the pressure p prevailing in the ignition prechamber 2, in order to transmit said pressure p to the computer 13 in real time.

In this case, the method for injecting an oxidiser-fuel gaseous mixture 1 according to the invention consists in correcting the filling injector electrical current profile 22 if said profile 22 does not lead to a prechamber filling pressure profile 35 such that it should be, taking into account the operating conditions of the internal combustion engine 4, as long as said pressure profile 35 is not sufficiently close to what it should be.

This last variant is particularly relevant if the ignition prechamber 2 receives a valve according to the patent WO2018/130772 belonging to the applicant, said variant being able to be applied identically to the scavenging electric current profile 29.

As another variant shown in FIG. 1, the method for injecting an oxidiser-fuel gaseous mixture 1 according to the invention can comprise a filling lift-flow conversion model 37 which determines, from the operating conditions of the internal combustion engine 4, from the filling lift law 23, and from the pressure measured by a pressure sensor 31 and the temperature measured by a temperature sensor 42 of the gaseous fuel mixture 14 to be introduced into the ignition prechamber 2 by the gaseous fuel mixture injector 9, a mass flow rate of filling gaseous fuel mixture 38 constituting the pilot charge 39 which is actually introduced by said injector 9 into said prechamber 2.

Said flow rate 38 can then be transmitted to the oxidiser-fuel mixer 18 so that the latter can adjust the proportion of fuel 16 to be introduced into the oxidiser 15 to produce the gaseous fuel mixture 14.

Similarly, and as illustrated in FIG. 1, the method for injecting an oxidiser-fuel gaseous mixture 1 according to the invention can comprise a scavenging lift-flow conversion model 49 which determines, from the operating conditions of the internal combustion engine 4, from the scavenging lift law 32, and from the pressure measured by a pressure sensor 31 and the temperature measured by a temperature sensor 42 of the gaseous fuel mixture 14 to be introduced into the ignition prechamber 2 by the gaseous fuel mixture injector 9, a mass flow rate of scavenging gaseous fuel mixture 50 which is actually introduced by said injector 9 into said prechamber 2.

As before, the result obtained is then transmitted to the oxidiser-fuel mixer 18 so that the latter can produce a mixture of oxidiser 15 and fuel 16 in the desired proportions.

As a variant of the method for injecting an oxidiser-fuel gaseous mixture 1 according to the invention, the filling electrical current profile 22, the recovery variable 25, the richness variable 27, the injection data set 28, the scavenging profile 29 and the triggering variable of the scavenging electrical current profile 45 can be recorded in the memory of the computer 13 and/or calculated in real time by the latter.

As another variant, the method for injecting an oxidiser-fuel gaseous mixture 1 according to the invention can measure from a camshaft angular position sensor 21 the camshaft angular position CSA to transmit to the computer 13 the angular position of the camshaft 8 relative to that of the internal combustion engine 4.

This being done and still according to this last variant, the method for injecting an oxidiser-fuel gaseous mixture 1 according to the invention uses the camshaft angular position CSA to determine to which crankshaft revolution of the internal combustion engine 4 is assigned the triggering variable of the filling electrical current profile 26 and the triggering variable of the scavenging electrical current profile 45, this being necessary if the thermodynamic cycle of the internal combustion engine 4 is carried out over more than one crankshaft revolution 7.

### Operation of the Invention

The operation of the method for injecting an oxidiser-fuel gaseous mixture 1 according to the invention is understood easily from FIG. 1.

The FIG. 1 shows, by way of non-limiting example, the method for injecting an oxidiser-fuel gaseous mixture 1 according to the invention, as can be advantageously applied to a spark ignition reciprocating internal combustion engine 4 which comprises a crankshaft 7, two camshafts 8 and a cylinder head 3, the latter forming, with a cylinder 46 and a piston 47, a main combustion chamber 6 into which an intake valve 48 can introduce a main charge 40 consisting of a mixture made of an oxidiser 15 and a fuel 16.

It can be seen in FIG. 1 that a crankshaft angular position sensor 20 measures the crankshaft angular position CA to transmit in real time to a computer 13 also denoted “ECU” the angular position of the crankshaft 7 relative to that of the internal combustion engine 4.

Since said engine 4 performs, according to this example, a four-stroke thermodynamic Otto cycle known per se, a camshaft angular position sensor 21 measures the camshaft angular position CSA and transmits to the computer 13 the angular position of one of the two camshafts 8 relative to that of said engine 4, which allows said computer 13 to distinguish the crankshaft revolution 7 where the compression and expansion of the Otto cycle take place, from the crankshaft revolution 7 where the exhaust and intake take place.

In FIG. 1, it has been shown that the method for injecting an oxidiser-fuel gaseous mixture 1 according to the invention is intended for an internal combustion engine 4 whose cylinder head 3 houses an ignition prechamber 2 into which open, on the one hand, the electrodes of a spark plug 19, and on the other hand, the tip of a gaseous fuel mixture injector 9 which can introduce into said prechamber 2 a gaseous fuel mixture 14 denoted “AF”, the latter forming a pilot charge 39.

In FIG. 1, it is noted that before being introduced into the ignition prechamber 2, the gaseous fuel mixture 14 was pressurised by compression means 17 such as a piston, a screw, avane compressor or any type known to the person skilled in the art, and was formed in an oxidiser-fuel mixer 18 such as, for example, the forced recirculation mixer which is the subject of the patent No. WO2021219943 belonging to the applicant, from an oxidiser 15 also denoted “A”, and a fuel 16 also denoted “F”.

It can be seen in FIG. 1 that the ignition prechamber 2 opens out into the main combustion chamber 6 via ignition torch emission openings 5 which place said prechamber 2 in communication with said chamber 6, so that when the pilot charge 39 is ignited by the spark plug 19 in said prechamber 2, ignition torches, not represented in said FIG. 1, are emitted into the main combustion chamber 6 in the form of high-temperature gases already burned, or in the process of combustion.

Said ignition torches have the function of igniting the main charge 40 by providing it with a heat and turbulent energy much higher than that ordinarily delivered by a simple spark plug.

This ignition strategy, known by the term “Turbulent J et ignition” from which the acronym “TJ I” derives, makes it possible to initiate the combustion of the main charge 40 at multiple points in the volume of the main combustion chamber 6, while generating a strong local turbulence that pleats the flame front and promotes rapid and complete combustion of said main charge 40.

Combined with a pilot charge 39 pre-prepared by means of an oxidiser-fuel mixer 18, said strategy makes it possible to effectively ignite any main charge 40, even if the latter is made of a fuel-lean mixture 16 with respect to stoichiometry, or if said charge 40 is close to stoichiometry but highly diluted with recirculated exhaust gases according to the strategy known by the acronym “EGR”, the lean mixture and the dilution to the “EGR” both requiring high ignition powers.

It should be recalled here that the combustion of fuel-lean mixtures 16 or mixtures highly diluted with the “EGR” that the ignition strategy by “TJ I” allows makes it possible to significantly increase the thermodynamic efficiency of the internal combustion engines 4 thanks, at least, to a reduction in the heat losses at the internal walls of said engine 4, to a moderation of the sensitivity to knocking of the fuel mixture introduced forming the main charge 40 which makes it possible to increase the compression ratio of said engine 4 and to optimise the angular timing of the combustion, and to a reduction in the losses by pumping at the intake of said engine 4.

If, in addition, the ignition prechamber 2 is provided with a lamination valve such as that described in the Patent WO2018/130772 belonging to the applicant and in the resulting improvement patents published in particular under No. WO2020053501 and WO2022/079367, it is possible to produce internal combustion engines 4 with high energy efficiency and low emissions, which are capable of meeting the functional requirements of a modern hybrid or non-hybrid automobile, and which emit few regulated or unregulated pollutants.

It can be easily deduced from the above that the way in which the combustion of the pilot charge 39 takes place in the ignition prechamber 2 determines the way in which the combustion of the main charge 40 takes place in the main combustion chamber 6.

In particular, the amount of energy contained in the pilot charge 39 and the rate at which this energy is released make it possible or not to burn the main charge 40 in optimal conditions.

For example, if the combustion of the pilot charge 39 is too rapid, there may be an over-mixing of the hot ignition torches with the cold main charge 40, which leads to an inefficient combustion of said charge 40, or even to a misfire of said charge 40.

If, on the contrary, the combustion of the pilot charge 39 is too slow and/or too low in energy, the combustion of the main charge 40 may also be too slow or even incomplete, which leads to a lower efficiency of the internal combustion engine 4 and to high polluting emissions.

These considerations are closely linked to the ignition strategy by “TJ I”, particularly when the latter is applied to internal combustion engines 4 subjected to large variations in torque, speed and power, and to infinitely variable operating conditions, which is the case, for example, with automotive internal combustion engines 4.

This explains in large part why, despite its many advantages, the “J IT” ignition strategy has long been applied to industrial internal combustion engines 4 operating at fixed speed and load, but not to internal combustion engines 4 dedicated to automotive propulsion.

Indeed, in an automotive internal combustion engine 4, the energy and the ignition power of the main change 40 which must be delivered by the combustion of the pilot charge 39 in the form of ignition torches must ideally vary constantly, in parallel with the operating conditions of the internal combustion engine 4.

To meet this hitherto unsatisfied need to control the energy and the ignition power of the main charge 40 according to the conditions of the internal combustion engine 4 is made possible by the method of injecting an oxidiser-fuel gaseous mixture 1 according to the invention, all the more effectively if said method 1 cooperates with an ignition prechamber 2 provided with a lamination valve such as that described in the patent WO2018/130772.

To achieve this result, the method for injecting an oxidiser-fuel gaseous mixture 1 according to the invention offers all the levers necessary to effectively control the combustion conditions of the pilot charge 39 and this, to obtain a combustion of said charge 39 close to the ideal both with regard to the energy released by said combustion, and with regard to the rate at which said energy is released, that is to say the power of said combustion.

It will be noted that inside the ignition prechamber 2, the gaseous fuel mixture 14 which forms the pilot charge 39 is subjected to the turbulence which results from its introduction into the said prechamber 2 via the gaseous fuel mixture injector 9, the said mixture 14 bathing the electrodes of the spark plug 19.

However, it is noted that the intensity of said turbulence has a direct impact on the capacity of said plug 19 to ignite 41 the pilot charge 39, and on the development of the combustion of said charge 39 in the ignition prechamber 2.

If the intensity of said turbulence is too low, the combustion of the pilot charge 39 initiated between the electrodes of the spark plug 19 may be too slow to develop, while if said intensity is too high, said combustion may eventually initialise, but with a high risk of being extinguished by blowing the incipient flame.

However, insofar as we remain in a level of turbulence compatible with the ignition 41 of the pilot charge 39 by the spak plug 19, it is noted that a turbulence of high intensity leads to a faster combustion of said charge 39 than a turbulence of lower intensity, which affects the rate of release of the energy contained in said charge 39 and therefore, on the power released by the combustion of said charge 39 to ignite the main charge 40 via ignition torches.

However, the intensity of the turbulence to which the pilot charge 39 is subjected at the time of its ignition 41 in the ignition prechamber 2 by the spark plug 19 is in particular dependent on the time offset between the time of said ignition 41 and the time when said charge 39 is introduced into said prechamber 2 by gaseous fuel mixture injector 9.

Indeed, during the introduction of the pilot charge 39 into the ignition prechamber 2 by the gaseous fuel mixture injector 9, the pressure of the gaseous fuel mixture 14 upstream of said injector 9 is greater than the pressure prevailing in the ignition prechamber 2.

As a result, the gaseous fuel mixture 14 entering said prechamber 2 is agitated with a more or less intense turbulence, the latter rapidly decreasing once the gaseous fuel mixture injector 9 is closed.

In this respect, the longer the delay between the end of the injection of the pilot charge 39 and its ignition 41, the less the turbulence of the gaseous fuel mixture 14 constituting said charge 39 in the ignition prechamber 2 is intense at the time of said ignition 41, the slower the combustion of the pilot charge 39, and the lower the power delivered by said combustion for the purpose of igniting the main charge 40.

On the contrary, if the ignition 41 of the pilot charge 39 is triggered by the spark plug 19 while the injection of said charge 39 into the ignition prechamber 2 is not completed, said ignition 41 takes place in a context of intense turbulence of the gaseous fuel mixture 14 constituting said charge 39, the combustion of the pilot charge 39 is rapid, and the power delivered by said combustion for the purpose of igniting the main charge 40 is high.

This is why the method for injecting an oxidiser-fuel gaseous fuel mixture 1 according to the invention uses a recovery variable 25 which sets, from the crankshaft angular position CA, the negative or positive crankshaft angular offset 7 between, on the one hand, the moment of ignition 41 of the pilot charge 39 in the ignition prechamber 2 by the spark plug 19, and, on the other hand, the resting of the injector needle 10 on its needle seat 11, said resting marking the end of the introduction of the pilot charge 39 into the ignition prechamber 2 by the gaseous fuel mixture injector 9.

There is therefore a direct link between the value of the recovery variable 25, on the one hand, and the intensity of the turbulence of the gaseous fuel mixture 14 constituting said charge 39 at the time of its ignition 41, on which depends the combustion power of said charge 39 delivered for the purpose of igniting the main charge 40, on the other hand.

In other words, if the ignition 41 of the pilot charge 39 occurs at a crankshaft angular position CA of a few degrees, for example ten or twenty degrees, earlier than the crankshaft angular position CA at which the injector needle 10 returns to rest on its needle seat 11, the ignition 41 and the introduction of the pilot charge 39 into the ignition prechamber 2 take place simultaneously, and said charge 39 is subjected to a high intensity turbulence at the time of said ignition 41.

If, on the other hand, the ignition 41 of the pilot charge 39 occurs at a crankshaft angular position CA of a few degrees, for example three to ten degrees, later than the crankshaft angular position CA at which the injector needle 10 returns to rest on its needle seat 11, the ignition 41 of the pilot charge 39 occurs only after the introduction of said charge 39 into the ignition prechamber 2 has been completed, then there is no longer any recovery between said ignition 41 and the introduction of the pilot charge 39 into the ignition prechamber 2, and said charge 39 is only subjected to a less intense turbulence at the time of said ignition 41.

In addition to the recovery between the ignition 41 and the introduction of the pilot charge 39 into the ignition prechamber 2, which conditions the intensity of the turbulence to which the gaseous fuel mixture 14 constituting the pilot charge 39 is subjected at the time of its ignition 41, it is noted that said intensity is all the greater as the flow rate of gaseous fuel mixture 14 delivered by the gaseous fuel mixture injector 9 is high at the time of said ignition 41.

This is why the way in which the same pilot charge mass 39 is introduced into the ignition prechamber 2 by the fuel gas mixture injector 9 also determines the intensity of the turbulence to which the fuel gaseous mixture 14 constituting said charge 39 is subjected at the time of its ignition 41 by the spark plug 19.

Said manner is defined by the filling lift law 23, which is itself determined by the filling electrical current profile 22 applied by the computer 13 to the electrical supply terminals 36 of the electrically controlled injection actuator 12.

For example, to introduce the same pilot charge mass 39 into the ignition prechamber 2, the injector needle 10 can lift from its needle seat 11 much but briefly so as to generate a turbulence of high intensity but brief, or on the contrary lift little but long, thus generating a turbulence of lesser intensity over a longer time.

There are therefore an infinite number of possibilities for adjusting the intensity of the turbulence with which the pilot charge 39 is animated at the time of its ignition 41 by the spark plug 19, whatever the mass of said pilot charge 39, and whatever the energy contained in said charge 39.

This is why the method for injecting an oxidiser-fuel gaseous mixture 1 according to the invention provides, on the one hand, a filling electrical current profile 22 which can take an infinity of forms and which can lead to an infinity of filling lift laws 23, and, on the other hand, a recovery variable 25 which can take an infinity of values and from which a triggering variable of the filling current profile 26 results.

The combination formed by the crankshaft angular position CA at the time of ignition 41 of the pilot charge 39, by the filling electrical current profile 22, and by the recovery variable 25, makes it possible to simultaneously adjust the energy, the power and the moment of ignition of the main charge 40 in the ignition prechamber 2.

By combining different values assigned to the recovery variable 25 with different filling electrical current profiles 22 leading to different filling lift laws 23, the method for injecting an oxidiser-fuel gaseous mixture 1 according to the invention therefore makes it possible to choose under all circumstances with what energy and what power released by the combustion of the pilot charge 39 the main charge 40 of a spark ignition internal combustion engine 4 is ignited.

This freedom makes it possible to operate said engine 4 under the most favorable conditions for high thermodynamic efficiency, minimum emissions, and optimal dynamic, acoustic and vibratory operation, particularly if the ignition prechamber 2 of said engine 4 is provided with a lamination valve such as that described in the patent WO2018/130772 belonging to the applicant.

Among the operating circumstances of the internal combustion engine 4, mention may be made of the idling speed and load, the intermediate speeds and loads, the speed and load transients, the full load, the full power, as well as the starting at low or even very low temperatures, the phase of reheating the pollutant post-treatment catalyst, and in general, all the points and modes of operation of an internal combustion engine 4 that is automotive or dedicated to any other application, without limitation.

As can be seen in FIG. 1, to further optimise the combustion of the pilot charge 39 and optionally, the method for injecting an oxidiser-fuel gaseous mixture 1 according to the invention provides a triggering variable of the scavenging electrical current profile 45 that corresponds to a crankshaft angular position CA to which the computer 13 applies a scavenging electrical current profile 29 to the electrical power supply terminals 36 of the electrically controlled injection actuator 12.

The scavenging electrical current profile 29 has the consequence of imposing on the injector needle 10 a scavenging lift law 32 which precedes the filling lift law 23, for example by some degrees of rotation of the crankshaft 7.

Throughout the resulting scavenging opening period 33, which occurs when the pressure prevailing in the main combustion chamber is low, the gaseous fuel mixture injector 9 introduces into the ignition prechamber 2 a small amount of gaseous fuel mixture 14, the function of which is to expel the residual burnt gases from the previous cycle so that, when the pilot charge 39 proper is introduced, the latter is as pure as possible and as little diluted as possible by said burnt gases.

Indeed, avoiding diluting the pilot charge 39 with residual burnt gases from the previous cycle makes said charge 39 more reactive and easy to ignite by the spark plug 19, the latter then being more durable because it is sufficient to deliver less electrical energy between its electrodes, while the combustion of the pilot charge 39 is more stable from one cycle to another.

The use of a triggering variable of the scavenging electrical current profile 45 and the scavenging lift law 32 associated with it, is all the more effective if the method for injecting an oxidiser-fuel gaseous mixture 1 according to the invention applies to an ignition prechamber 2 provided with a lamination valve such as that described in the patent WO2018/130772.

Since the fuel richness of the gaseous fuel mixture 14 constituting the pilot charge 39 also plays a predominant role in the combustion rate of said charge 39 in the ignition prechamber 2 and in the efficiency of said charge 39 in igniting the main charge 40, the method for injecting an oxidiser-fuel gaseous mixture 1 according to the invention incorporates a richness variable 27.

Indeed, depending on the fuel richness 16 of the gaseous fuel mixture 14 constituting the pilot charge 39, during the combustion of the latter, the gases ejected at high temperature from the ignition prechamber 2 to the main combustion chamber 6 via the emission openings of the ignition torch 5 may contain more or less hydroxyl radicals, carbon monoxide or unburnt hydrocarbons, these chemical species playing a preponderant role on the efficiency and the kinetics of the combustion of the main charge 40.

It should also be noted that the fuel richness 16 of the gaseous fuel mixture 14 also has a strong impact on the rate of combustion of the pilot charge 39 in the ignition prechamber 2, knowing that a fuel richness 16 of the order of one point two to one point three times the stoichiometry constitutes a good compromise in most cases.

That is why, taking into account the above, the method for injecting an oxidiser-fuel gaseous mixture 1 according to the invention provides for grouping the main parameters influencing the combustion of the pilot charge 39 in the ignition prechamber 2 in the form of an injection data set 28 which is written into the memory of the computer 13 and/or which is calculated in real time by the latter.

Said set 28 comprises, for each operating point of the internal combustion engine 4, a filling electrical current profile 22, a value assigned to the recovery variable 25, a value assigned to the triggering variable of the filling current profile 26, and a value assigned to the richness variable 27, to which may be added a triggering variable of the scavenging electrical current profile 45 and a scavenging electrical current profile 29.

Thus, the injection data set 28 sets the quantity, the composition and the turbulence of the gaseous fuel mixture 14 constituting the pilot charge 39 at the time of ignition 41 of said mixture 14, which determines the rate of combustion of said mixture 14 in the ignition prechamber 2, the heat power released by said combustion, the chemical species emitted in the main combustion chamber 6 and therefore the efficiency of said combustion in igniting the main charge 40 in the main combustion chamber 6 and in promoting as rapid and complete as possible combustion of said main charge 40.

The possibilities of the method for injecting an oxidiser-fuel gaseous mixture 1 according to the invention are not limited to the applications that have just been described, and moreover it must be understood that the above description was given only as an example and in no way limits the scope of said invention which would not be exceeded by replacing the details of execution described by any other equivalent.

1. A method for injecting an oxidiser-fuel gaseous fuel mixture (1) into an ignition prechamber (2) which comprises a cylinder head (3) of a spark ignition reciprocating internal combustion engine (4), said prechamber (2) having at least one ignition torch emission opening (5) which opens into a main combustion chamber (6) which comprises said engine (4) and into which a main charge (40) consisting of an oxidiser (15) and a fuel (16) can be introduced, said engine (4) also comprising at least one crankshaft (7), at least one camshaft (8), and at least one gaseous fuel mixture injector (9) which opens into the ignition prechamber (2), said injector (9) comprising at least one injector needle (10) which can either rest in a sealed manner on a needle seat (11), said injector (9) then being closed, or can be lifted from said seat (11) by an electrically controlled injection actuator (12) controlled by a computer (13), said injector (9) then being opened, which has the effect of introducing into said prechamber (2) a pilot charge (39) formed of a gaseous fuel mixture (14) which consists of an oxidiser (15) and a fuel (16) and which has been previously pressurised by compression means (17), said mixture (14) having been formed in an oxidiser-fuel mixer (18), while the ignition (41) of the pilot charge (39) in the ignition prechamber (2) can be triggered by the computer (13) by means of a spark plug (19) which opens into said prechamber (2), characterized in that it consists in:
Measuring, by means of a crankshaft angular position sensor (20), the crankshaft angular position (CA) to transmit to the computer (13) the angular position of the crankshaft (7) relative to that of the internal combustion engine (4);
Using at least one filling electrical current profile (22) that can be applied by the computer (13) to electrical supply terminals (36) that the electrically controlled injection actuator (12) has, said profile (22) being provided to impose on the injector needle (10) a filling lift law (23) from which follows, on the one hand, the temporal evolution of the position of said needle (10) relative to that of the needle seat (11) with which it cooperates, and, on the other hand, a filling opening period (24) of the gaseous fuel mixture injector (9);
Using a recovery variable (25) that sets the offset between, on the one hand, the crankshaft angular position (CA) at the time of ignition (41) of the pilot charge (39) in the ignition prechamber (2) by the spark plug (19), and, on the other hand, the crankshaft angular position (CA) at the time of resting the injector needle (10) on the needle seat (11) with which it cooperates;
Using a triggering variable of the filling electrical current profile (26) that sets, according to the recovery variable (25), the crankshaft angular position (CA) from which the computer (13) applies the filling electrical current profile (22) to the electrical supply terminals (36) of the electrically controlled injection actuator (12), said triggering variable (26) being calculated by said computer (13), on the one hand, from the crankshaft angular position (CA) from which the ignition (41) of the pilot charge (39) in the ignition prechamber (2) is triggered by the computer (13), and, on the other hand, from the filling opening period (24) of the gaseous fuel mixture injector (9) that is imposed by the filling electrical current profile (22);
Using a richness variable (27) which sets the mass proportion of oxidiser (15) and fuel (16) which make up the gaseous fuel mixture (14) constituting the pilot charge (39) produced by the oxidiser-fuel mixer (18);
Generating for each operating point of the engine (4) an injection data set (28) which comprises a filling electrical current profile (22), a value assigned to the recovery variable (25), a value assigned to the triggering variable of the filling current profile (26), and a value assigned to the richness variable (27), said set (28) setting the quantity, the composition and the turbulence of the gaseous fuel mixture (14) constituting the pilot charge (39) at the time of ignition (41) of said mixture (14), which determines the rate of combustion of said mixture (14) in the ignition prechamber (2), on the one hand, and the heat power released by said combustion, on the other hand;
Running the injection data set (28) corresponding to the operating point of the internal combustion engine (4).

2. The method for injecting a gaseous fuel mixture according to claim 1, characterised in that it consists in:
Using a triggering variable of the scavenging electrical current profile (45) that sets a crankshaft angular position (CA);
Applying, to the crankshaft angular position (CA) resulting from the triggering variable of the scavenging electrical current profile (45) and via the computer (13), a scavenging electrical current profile (29) to the electrical supply terminals (36) of the electrically controlled injection actuator (12), said scavenging profile (29) being provided to impose on the injector needle (10) a scavenging lift law (32) from which follows, on the one hand, the temporal evolution of the position of said needle (10) relative to the needle seat (11), and, on the other hand, a scavenging opening period (33) of the gaseous fuel mixture injector (9).

3. The method for injecting a gaseous fuel mixture according to claim 1, characterised in that it consists in:
Measuring by means of an injector needle position sensor (30) the distance (d) between the injector needle (10) and the needle seat (11) to transmit said distance (d) to the computer (13) in real time;
Correcting the filling electrical current profile (22) if the latter does not lead, on the one hand, to the filling lift law (23) of the injector needle (10), and, on the other hand, to the filling opening period (24) of the gaseous fuel mixture injector (9), as originally provided by said profile (22).

4. The method of injecting a gaseous fuel mixture according to claim 2, characterised in that it consists in:
Measuring by means of an injector needle position sensor (30) the distance (d) between the injector needle (10) and the needle seat (11) to transmit said distance (d) to the computer (13) in real time;
Correcting the scavenging electrical current profile (29) if it does not lead, on the one hand, to the scavenging lift law (32) of the injector needle (10), and, on the other hand, to the scavenging opening period (33) of the gaseous fuel mixture injector (9), as originally provided by said profile (29).

5. The method of injecting a gaseous fuel mixture according to claim 1, characterised in that it consists in:
Measuring by means of a prechamber pressure sensor (34) the pressure (p) prevailing in the ignition prechamber (2) to transmit said pressure (p) to the computer (13) in real time;
Correcting the filling injector electrical current profile (22) if said profile (22) does not lead to a prechamber filling pressure profile (35) as it should be, taking into account the operating conditions of the internal combustion engine (4).

6. The method for injecting a gaseous fuel mixture according to claim 1, characterised in that it comprises a lift-flow conversion model (37) which determines, from the operating conditions of the internal combustion engine (4), from the filling lift law (23), and from the pressure measured by a pressure sensor (31) and the temperature measured by a temperature sensor (42) of the gaseous fuel mixture (14) to be introduced into the ignition prechamber (2) by the gaseous fuel mixture injector (9), a mass flow rate of the gaseous fuel mixture (38) constituting the pilot charge (39) which is actually introduced by said injector (9) into said prechamber (2).

7. The method for injecting a gaseous fuel mixture according to claim 2, characterised in that it comprises a scavenging lift/flow conversion model (49) which determines, from the operating conditions of the internal combustion engine (4), from the scavenging lift law (32), and from the pressure measured by a pressure sensor (31) and the temperature measured by a temperature sensor (42) of the gaseous fuel mixture (14) to be introduced into the ignition prechamber (2) by the gaseous fuel mixture injector (9), a mass flow rate of scavenging gaseous fuel mixture (50) which is actually introduced by said injector (9) into said prechamber (2).

8. The method for injecting a gaseous fuel mixture according to claim 1, characterised in that the filling electrical current profile (22), the recovery variable (25), the richness variable (27), the injection data set (28), the scavenging profile (29) and the triggering variable of the scavenging electrical current profile (45) are recorded in the memory of the computer (13) and/or calculated in real time by the latter.

9. The method for injecting a gaseous fuel mixture according to claim 1, characterised in that it consists in:
Measuring, by means of a camshaft angular position sensor (21), the camshaft angular position (CSA) to transmit to the computer (13) the angular position of the camshaft (8) relative to that of the internal combustion engine (4);
Using the camshaft angular position (CSA) to determine which crankshaft revolution of the internal combustion engine (4) is affected by the triggering variable of the filling electrical current profile (26) and the triggering variable of the scavenging electrical current profile (45).
